(19) United States
(12) Patent Application Publication
(10) Pub. No.: US 2014/0230052 A1
(43) Pub. Date: Aug. 14, 2014

(54) SYSTEM AND METHOD FOR TESTING A SECURED MANUFACTURED DEVICE

(71) Applicant: MOTOROLA MOBILITY LLC, Libertyville, IL (US)

(72) Inventors: Jiang Zhang, San Diego, CA (US); William P. Franks, San Diego, CA (US)

(73) Assignee: MOTOROLA MOBILITY LLC, Libertyville, IL (US)

(21) Appl. No.: 13/763,844

(22) Filed: Feb. 11, 2013

(51) Int. Cl. G06F 21/44

(52) U.S. Cl. CPC G06F 21/44
USPC 726/22

(57) ABSTRACT

A system includes a device booting portion, an MTC loading portion and a verifying portion. The device booting portion can boot a manufactured device. The MTC loading portion can receive secure manufacturing test code from an MTC providing portion when the manufactured device does not have manufacturing test code stored therein. The verifying portion can verify the authenticity of secure manufacturing test code and can generate a verification. The MTC loading portion can further load the secure manufacturing test code into the booted manufactured device based on the verification.

### BACKGROUND

Some electronic devices are secure, such that, among other features, they include data therein that should not be accessible to anyone without proper authority. Some secure electronic devices provide further security such that only an authorized code may be loaded therein for the device to execute. In some of these secure electronic devices; such as in some set-top-boxes, for example, the data is secured by way of cryptographic means, wherein once the cryptographic data is loaded into the electronic device, the electronic device may be fully tested with a Manufacturing Test Code (MTC). The MTC tests the hardware features of the electronic device. Once tested, the MTC may be disabled or removed from the unit and a secure boot may be turned on permanently before shipping out of the factory. The secure boot should ensure that only an authorized production code runs on the unit.

However, downstream quality assurance testing may sometimes require that some product samples be randomly selected from the units that are ready to ship to customers. Each of these randomly selected sample units may have the MTC re-executed thereon to test and verify the product's quality. This is not a problem for non-secure products. However, for secure products, such as those having a secure boot enabled and having the MTC disabled (or entirely removed), new MTC may not be authorized to be loaded or executed thereon. If the security of a tested electronic device were compromised to enable new MTC to be executed thereon, the compromised security of the device, when shipped to a customer, may enable a subsequent attacker to break the secure boot and run unauthorized code on the unit.

### BRIEF SUMMARY OF THE DRAWINGS

The accompanying drawings, which are incorporated in and form a part of the specification, illustrate example embodiments of the invention and, together with the description serve to explain the principles of the invention. In the drawings:

FIG. 1 illustrates an example prior art system for testing a manufactured device;

FIG. 2 illustrates a prior art method for the system as described with reference to FIG. 1;

FIG. 3 illustrates the manufactured device of FIG. 1 for use at a customer site;

FIG. 4 illustrates a prior art method for the system as described with reference to FIG. 3;

FIG. 5 illustrates a testing device for connecting to a Manufacturing Test Code (MTC) provider, authenticating MTC provider, downloading the MTC from MTC provider, authenticating the MTC, executing manufacture test associated with the MTC and deleting the MTC from reprogrammable non-volatile memory upon successful completion of the test;

FIG. 6 illustrates a method for the testing device as described with reference to FIG. 5;

FIG. 7 illustrates an example system;

FIG. 8 illustrates a method for the system as described with reference to FIG. 5;

FIG. 9 illustrates an example system;

FIG. 10 illustrates a method for the system as described with reference to FIG. 9; and

FIG. 11 illustrates an example communication exchange diagram for system as described with reference to FIGS. 7-8.

### DETAILED DESCRIPTION

In some secure devices, non-limiting examples of which include set-top-boxes, before cryptographic data is loaded into the device and the unit is tested, a secure initialization program code is installed prior to shipment from the factory. Secure initialization program codes are secure because they include authorized code, which is provided by an authorized provider, and which is externally inaccessible. A secure initialization program code enables execution of an authorized program code on the device and rejects unauthorized program codes. The MTC, which is used to load cryptographic data and test the device's hardware features, is disabled or removed prior to packaging and shipment from the factory.

Following a manufacture test and removal, or disabling of MTC, devices passing testing are configured with serial numbers in order to uniquely identify each unit. For inventory and tracking purposes, customers sometimes require received devices to have sequential serial numbers. Following application of serial numbers, a device is processed and packaged for delivery to customers. Packaging often includes applying shrink wrap and other types of material for enclosing the device. Device testing often requires re-testing a random sample of a number of devices which are deemed ready for shipment. A selected device will be removed from the packaging for re-testing, thus destroying any security associated with the packaging. However, for a secure device, which has had the MTC removed, the initialization program code rejects attempts to perform re-testing as the MTC is not available for performing re-testing. Furthermore, due to the customer's sequential serial number requirement, the device removed in order to perform re-testing needs to be repackaged and delivered to the customer with its originally assigned serial number. Therefore, the configuration of the re-tested device needs to be returned to its condition prior to selection for re-testing. For example, the condition prior to re-testing may require the MTC to be removed or disabled, which then needs to be reestablished following re-testing.

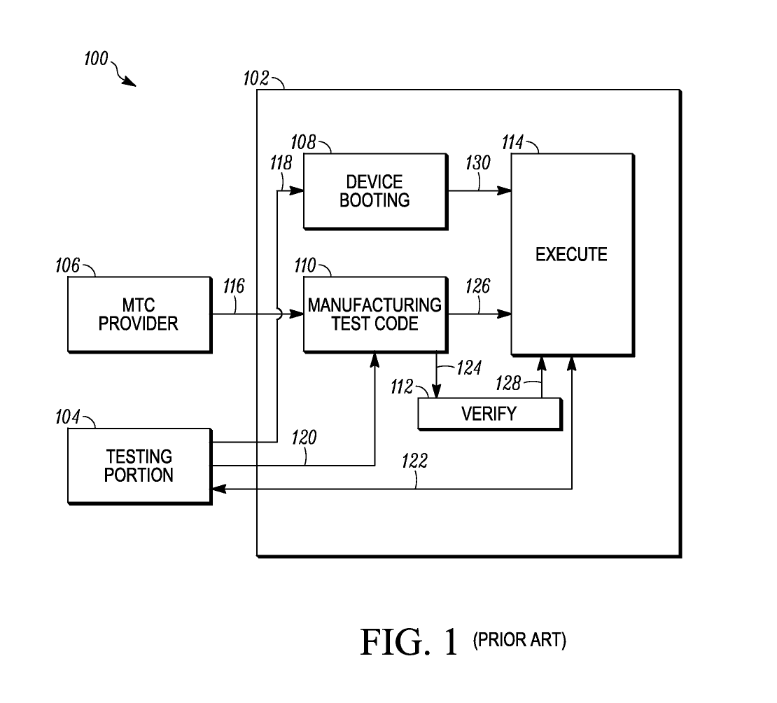

FIGS. 1-4 illustrate an example system for performing manufacture tests associated with MTC.

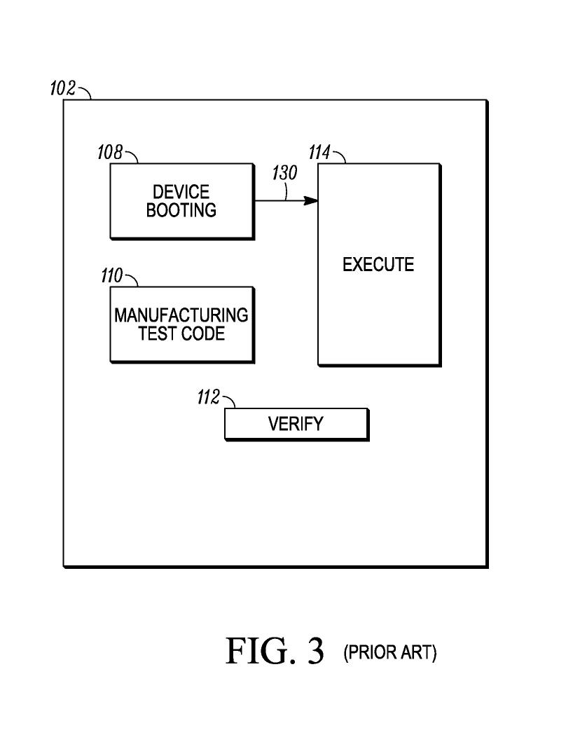

FIGS. 1 and 3 illustrate an example system 100.

FIG. 1 illustrates an example system 100 for testing a manufactured device 102, such as a set-top-box.

System 100 includes manufactured device 102, a testing portion 104 and an MTC providing portion 106. Manufactured device 102 includes a device booting portion 108, an MTC loading portion 110, a verifying portion 112 and an executing portion 114. In this example, each of device booting portion 108, MTC loading portion 110, verifying portion 112 and executing portion 114 are distinct devices. However, in other embodiments, at least two of device booting portion 108, MTC loading portion 110, verifying portion 112 and executing portion 114 may be combined as a unitary device. Further, in some embodiments, at least one of device booting portion 108, MTC loading portion 110, verifying portion 112 and executing portion 114 may be implemented using non-transient, tangible computer-readable media for carrying or having computer-executable instructions or data structures stored thereon. Such non-transient, tangible computer-readable media can be any available media that can be accessed by a general purpose or special purpose computer. Non-limiting examples of non-transient, tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a non-transient, tangible computer-readable media computer-medium. Thus, any such connection is properly termed a non-transient, tangible computer-readable medium. Combinations of the above should also be included within the scope of non-transient, tangible computer-readable media.

MTC providing portion 106 is arranged to communicate with MTC loading portion 110 via a communication channel 116.

Testing portion 104 is arranged to communicate with device booting portion 108 via a communication channel 118. Testing portion 104 is additionally arranged to communicate with MTC loading portion 110 via a communication channel 120. Testing portion 104 is further arranged to communicate with executing portion 114 via a communication channel 122.

Executing portion 114 is arranged to communicate with device booting portion 108 via a communication channel 130, with MTC loading portion 110 via a communication channel 126 and with verifying portion 112 via a communication channel 128. Verifying portion 112 is arranged to communicate with MTC loading portion 110 via a communication channel 124.

Device booting portion 108 is operable to provide booting instructions for booting manufactured device 102. As an example, device booting portion 108 may provide configuration information. MTC loading portion 110 is operable to provide MTC for performing manufacturing tests to verify whether the manufactured device functions correctly. Verifying portion 112 is operable to verify the authenticity of the MTC. This authenticity verification may be performed by any known method, a non-limiting example of which includes those using digital certificates, public key exchanges and private key exchanges. Executing portion 114 is operable to execute the booting instructions, the MTC and to operate in the manner in which manufactured device 102 is intended to operate, e.g., as a set-top-box in the case where manufactured device 102 is a set-top-box.

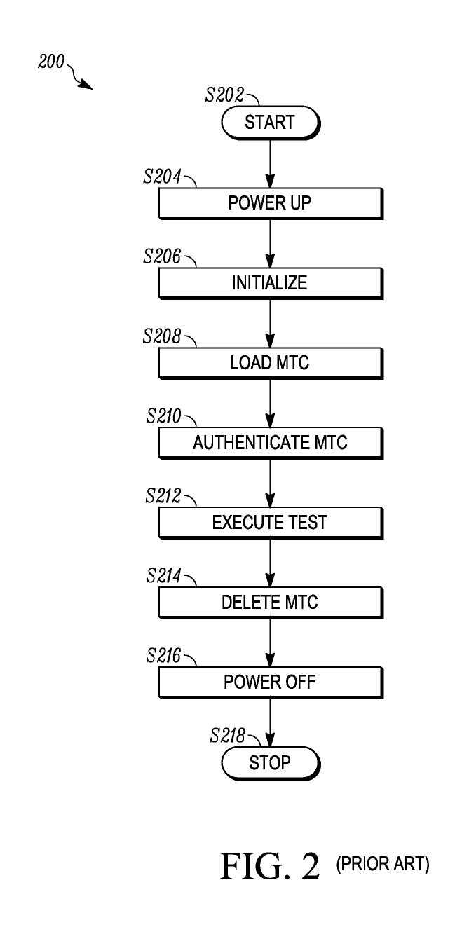

A process for the operation of the example system described with reference to FIG. 1 will now be presented with additional reference to FIG. 2.

As shown in FIG. 2, method 200 starts (S202) by powering up manufactured device 102 (S204). For example, manufactured device 102 may be randomly selected, from a group of manufactured devices for testing, after assembly, but prior to shipping. As shown in FIG. 1, manufactured device 102 is connected to testing portion 104 and to MTC providing portion 106. Power is then applied to system 100. Any system or method for providing power may be used, examples of which include a battery and wire power supply.

Returning to FIG. 2, the manufactured device is then initialized (S206). For example, as shown in FIG. 1, testing portion 104 may instruct device booting portion 108, via communication channel 118, to boot manufactured device 102. In response, device booting portion 108 may provide booting protocols, via communication channel 130 to executing portion 114. Device booting portion 108 may then instruct executing portion 114, via communication channel 130, to execute the booting protocols. Non-limiting examples of booting protocols include diagnostic tests (e.g., memory test) and configuration of hardware for mode of operation of the manufactured device to be tested.

Returning to FIG. 2, the MTC is then loaded (S208). For example, as shown in FIG. 1, MTC providing portion 106 provides MTC to MTC loading portion 110 via communication channel 116.

Returning to FIG. 2, the MTC is then authenticated (S210). For example, as shown in FIG. 1, testing portion 104 instructs MTC loading portion, via communication channel 120, to provide a copy of the received MTC to verifying portion 112. MTC loading portion then provides a copy of MTC to verifying portion 112 via communication channel 124. Verifying portion 112 then authenticates the MTC. Any known method of authentication may be used, a non-limiting example of which includes those using digital certificates, public key exchanges and private key exchanges. In short, unauthorized MTC should not be loaded onto a device. To ensure that unauthorized MTC is not loaded, any MTC that is attempted to be loaded must be authenticated. If the MTC is not authentic, verifying portion 112 does not pass the MTC onto executing portion 114. Once the MTC is authenticated, it is able to be loaded. Verifying portion 112 then generates an MTC verification and provides the MTC verification to executing portion 114 via communication channel 128.

Returning to FIG. 2, the MTC is then executed (S212). For example, as shown in FIG. 1, testing portion 104 instructs MTC loading portion 110, via communication channel 120, to load the MTC into executing portion 114. MTC loading portion 110 then loads the MTC into executing portion 114 via communication channel 126. Testing portion 104 additionally instructs executing portion 114, via communication channel 122, to execute the MTC as provided by MTC loading portion 110. After receiving the MTC from MTC loading portion 110, receiving an instruction from testing portion 104 and receiving the MTC verification from verifying portion 112, executing portion 114 executes the MTC. Testing portion 104 then monitors the results of executed MTC. If there are any errors, the test may be repeated, the manufactured device may be returned to the beginning of the manufacturing line or the manufactured device may be discarded.

Returning to FIG. 2, the MTC is then deleted (S214). For purposes of discussion, in this example testing portion 104 has determined that manufactured device 102 has executed the MTC without any errors. In such a case, for example, testing portion 104 then removes the MTC from MTC loading portion 110 prevent further execution and to prevent third parties from accessing the MTC.

Returning to FIG. 2, power is removed (S216). For example, manufactured device 102 is disconnected from power, from testing portion 104 and from MTC providing portion 106. At this point, method 200 is complete (S218).

FIG. 2 illustrates a method for the system as described with reference to FIG. 1, where a device is removed from packaging prior to distribution. The device is re-tested. If the device passes re-testing, then it needs to be reconfigured, in order to be delivered to customers.

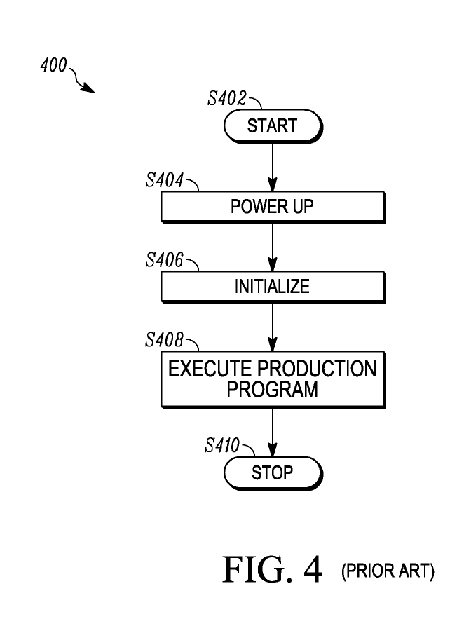

Devices not removed from packaging and not tested are distributed to customers. Operation of untested devices and re-tested/reconfigured devices operation will be described with reference to FIGS. 3-4.

FIG. 3 illustrates manufactured device of 102 FIG. 1 for use at a customer site.

This may be case wherein either MTC loading portion 110 is removed, or the MTC is removed from MTC loading portion 110, following testing as described with reference to FIG. 1. The configuration as described with reference to FIG. 3 operates similarly as in FIG. 1, except MTC loading portion 110 includes no MTC and verifying portion 112 does nothing. Since the MTC is no longer within MTC loading portion 110, the device is either untested or has been tested, for example, in accordance with method 200.

FIG. 4 illustrates a method 400 for system 100, as described with reference to FIG. 3, of initialization and execution of production program instructions.

As shown in FIG. 4, method 400 starts (S202) by powering up (S204). For example, as shown in FIG. 3, power is applied to manufactured device 102.

Returning to FIG. 4, system is initialized (S206). For example as shown in FIG. 3, executing portion 114 receives booting instructions from device booting portion 108, via communication channel 130, to boot manufactured device 102.

Returning to FIG. 4, production program code is executed (S402). For example, as shown in FIG. 3, executing portion 114 performs operation of production operational computer instructions. For example, manufactured device 102 may perform operations associated with a cable set-top box for receiving television programming information.

FIG. 4 illustrates a method for system as described with reference to FIG. 3 where a system powers up, initializes and performs production program instructions.

For the system as described with reference to FIGS. 1-4, a device may be sampled for re-testing prior to delivery. A sampled device is downloaded/configured with diagnostic information needed for re-testing. A re-tested device can pass or fail re-testing. A failed device may be repaired or replaced. Due to configuration needed for performing testing, a passing device is not suitable for deliver to customers, users, etc. In order to configure for the customer, user, etc., the re-tested device is reconfigured (e.g. reprocessed through manufacturing line) without downloaded diagnostic information, such that it may be delivered to customers, users, etc. For system, no method is available which enables delivery of a device to customers, users, etc. following re-testing and passing without performing the process of reconfiguring the device (e.g. reprocessed through manufacturing line) such that it does not contain downloaded diagnostic information.

Systems and methods are discussed herein for performing secure manufacture tests associated with the MTC. A local server embodiment and a flash drive embodiment will be described for implementing secure manufacture test. The systems and methods presented prevent unauthorized entities from loading and executing unauthorized programming code.

In order to provide manufacture testing for secure devices, memory and storage devices are used for communication with secure device to be tested for retrieval of the MTC. A local server or a flash drive may provide the MTC.

For an embodiment using a local server, a local server is configured in the factory's local private network with a pre-configured Internet Protocol (IP) address or domain name, such that the secure device to be tested is networked for access with the local server.

The local server contains a white list of Unit Identifiers (UID) of the selected device sample units to be tested. The white list represents a list of UIDs which are allowed to execute the MTC. The white list is maintained in a secure manner. Additionally, a list of secure devices which have passed the manufacturing test may be maintained on the local server.

When the secure device is powered up, it initiates by executing secure initialization program instructions. As an example, the Read Only Memory (ROM) initialization code will initialize followed by loading of an Application Boot Loader (ABL) which is authenticated and executed. The ABL then loads and authenticates Universal Bootloader (U-Boot) programming code and initializes execution of the U-Boot programming code. U-Boot is an open source, primary boot loader used in embedded devices.

The U-Boot programming code verifies if the tests associated with the MTC have been completed in prior operation. If the manufacturing tests have not been completed, the U-Boot programming code will load the MTC from programmable memory, authenticate the MTC and execute the MTC. If the manufacturing tests have been completed in prior operation, the U-Boot programming code will attempt to connect to a local server using the pre-configured IP address or domain name stored in a configuration file located on the secure device to be tested. The secure device attempts to connect to the local server in order to determine if the manufacture test code needs to be re-executed. In order to re-execute the MTC, the secure device to be tested is connected to the private local network containing to the local server and is powered up.

If the secure device determines the local server is available, then the secure device retrieves its unit identifier and randomly generates a Nonce. A Nonce represents an arbitrary number used one time in cryptographic communication. A Nonce is often a random or pseudo-random number. The retrieved unit identifier and generated Nonce are communicated to the local server which initiates the user identification protocol.

After the local server receives the unit identifier and Nonce information from the secure device, the server determines if the unit identifier is listed in the white list. If the secure device unit identifier is not in the white list, the server will communicate an error message to the secure device. If the local server determines the secure device unit identifier is in the white list, then the server will use its private key to sign the received secure device unit identifier and the received Nonce. A private key is a component of public-key cryptography where a private key is maintained as a secret and a public key is maintained as public. One key locks or encrypts information and the other key unlocks or decrypts information. Neither key performs both functions of encrypting and decrypting. The local server then communicates the signed unit identifier and Nonce information to the secure device.

The private key maintained on the local server is protected via a secure token issued via a Public Key Infrastructure (PKI) center. Security tokens are used to prove a person's identity electronically. A token may be used in addition to or in place of a password for verification of identity. Secure tokens are securely managed and typically tokens are unique to a factory. Furthermore, secure token may be provided by a hardware or software mechanism. For a lost or disclosed private key, the U-Boot code programming code is updated in order to disable access via the lost or disclosed public key.

After the secure device receives the signed unit identifier and Nonce information, the unit verifies the unit identifier and Nonce information match the previously transmitted information. If the unit identifier and Nonce information do not match, then the unit continues with execution of the secure initialization process. If the unit identifier and Nonce information do match the previously transmitted information, then the secure device attempts to verify the signature using the local server's public key. A signature provides a mathematical scheme for demonstrating the authenticity associated with a digital message or document. A valid signature provides a recipient with a reason to believe the message or document was created by an authorized entity. As an example, the local server's public key may be hard coded in the secure devices reprogrammable non-volatile memory. If the secure device successfully verifies the signature, then the secure device is securely connected to the local server and may download and execute the MTC for performing manufacture tests. Secure device then downloads the MTC from the local server and stores the information in volatile memory (e.g., RAM). Furthermore, the secure device authenticates the MTC using its programming code authentication key.

If the MTC is authenticated, then the secure device continues to execute the MTC for performing manufacture tests. When all manufacture tests are completed, the MTC is removed from the secure device. If the MTC is stored in reprogrammable non-volatile memory, then the MTC is removed from reprogrammable non-volatile memory. Following removal of the MTC, power is removed from the secure device.

For an embodiment using a flash drive, a signed access token is received from a PKI server. The signed access token allows a secure device to load the MTC into the secure device for execution. The signed access token may include unit identification information for a unit or units and/or token expiration information.

The signed access token and signed MTC is stored onto a flash drive in a specific location and/or with a specific file name.

Following application of power, the secure device initiates secure initialization program code. The secure device may initiate ROM initialization programming code followed by loading, authenticating and executing ABL programming code. The ABL programming code will then load, authenticate and initiate the U-Boot programming code.

The U-Boot programming code checks for prior execution of the MTC. If the MTC has not previously been executed, the U-Boot programming code will load the MTC from programmable memory, authenticate and execute the MTC, if it passes authentication. If execution of MTC has been previously performed, secure device determines if flash drive is connected to secure device. If the flash drive is not available, then the secure device will continue the secure initialization process and execute application programming code.

If the secure device determines the flash drive is available, then the secure device determines if the access token file is available. The file path to the access token may be pre-configured, either in the configuration file or hard coded in the programming code associated with the secure device. If the secure device determines the secure token is present, the secure device verifies the signature of the token using a hard coded token verification public key. If the signature is verified, then the secure device may verify the unit identification associated with the token matches the unit identification for the secure device. Furthermore, the secure device may determine if the token is valid. If the UID is determined as not matching or the token is determined invalid, then the secure devices continues with secure initialization process. If verification is determined, the MTC may securely be downloaded and executed.

For successful verification, the secure device downloads the MTC from the flash drive into volatile memory (e.g. RAM) and performs authentication of the programming code using the secure devices authentication key. In some embodiments where a secure device reinitializes during testing, the MTC may be stored in programmable memory (e.g. flash) associated with the secure device.

After authentication of the MTC by the secure device, the secure device executes the manufacture tests associated with the MTC. Following completion of the test, the MTC is removed from the secure device. If the MTC is stored in programmable memory (e.g. flash), then the MTC is removed from the programmable memory. Following removal of MTC, power is removed from the secure device.

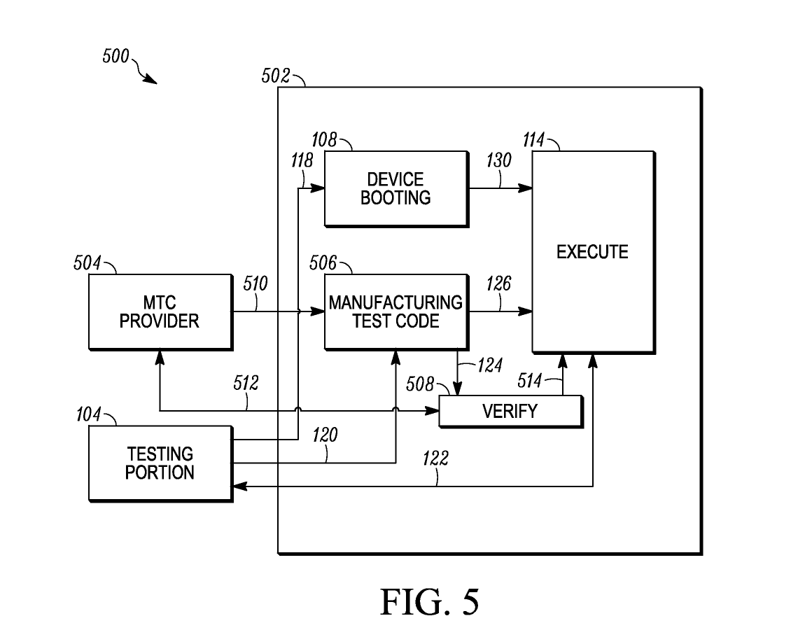

Example aspects of the present invention will now be described in greater detail with reference to FIGS. 5-11.

FIG. 5 illustrates an example testing device 500 for connecting to an MTC provider, authenticating MTC provider, downloading the MTC from MTC provider, authenticating the MTC, executing manufacture test associated with the MTC and deleting the MTC from reprogrammable non-volatile memory upon successful completion of the test.

System 500 includes manufactured device 502, testing portion 104 and an MTC providing portion 504. Manufactured device 502 includes device booting portion 108, an MTC loading portion 506, a verifying portion 508 and executing portion 114.

In this example, each of device booting portion 108, MTC loading portion 506, verifying portion 508 and executing portion 114 are distinct devices. However, in other embodiments, at least two of device booting portion 108, MTC loading portion 506, verifying portion 508 and executing portion 114 may be combined as a unitary device. Further, in some embodiments, at least one of device booting portion 108, MTC loading portion 506, verifying portion 508 and executing portion 114 may be implemented using non-transient, tangible computer-readable media for carrying or having computer-executable instructions or data structures stored thereon.

MTC providing portion 504 is arranged to communicate with MTC loading portion 506 via a communication channel 510.

Testing portion 104 is arranged to communicate with device booting portion 108 via communication channel 118. Testing portion 104 is additionally arranged to communicate with MTC loading portion 506 via communication channel 120. Testing portion 104 is further arranged to communicate with executing portion 114 via communication channel 122.

Executing portion 114 is arranged to communicate with device booting portion 108 via communication channel 130, with MTC loading portion 506 via communication channel 126 and with verifying portion 508 via a communication channel 514. Verifying portion 508 is arranged to communicate with MTC loading portion 506 via a communication channel 124 and is arranged to communicate with MTC providing portion 504 via a communication channel 512.

MTC loading portion 506 is operable to provide MTC for performing manufacturing tests to verify whether the manufactured device functions correctly. Verifying portion 508 is operable to verify the authenticity of the MTC and to verify the authenticity of the provider of the MTC. This authenticity verification may be in the form of two separate verifications or a single verification and may be performed by any known method, a non-limiting example of which includes those using digital certificates, public key exchanges and private key exchanges. Executing portion 114 is operable to execute the booting instructions, the MTC and to operate in the manner in which manufactured device 502 is intended to operate, e.g., as a set-top-box in the case where manufactured device 502 is a set-top-box.

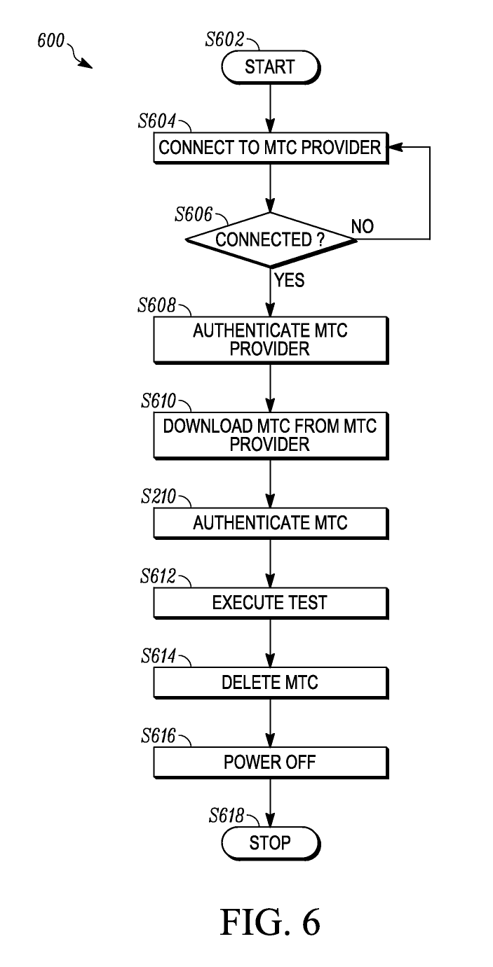

A process for the operation of the example system described with reference to FIG. 5 will now be presented with additional reference to FIG. 6.

FIG. 6 illustrates a method 600 for testing device 500 as described with reference to FIG. 5.

The method as described by FIG. 6 provides connection, authentication of MTC provider, download of MTC information, authentication of downloaded MTC information, execution of MTC information and deletion of MTC information.

As shown in FIG. 6, method 600 starts (S602) by connection to MTC provider (S604). For example, manufactured device 502 may be randomly selected, from a group of manufactured devices for testing, after assembly, but prior to shipping. As shown in FIG. 5, manufactured device 502 is connected MTC providing portion 504. Power is then applied to system 500. Any system or method for providing power may be used, examples of which include a battery and wire power supply. Information may be provided between manufactured device 502 and MTC provider portion 504, via communication channel 510, such that a connection is established.

Returning to FIG. 6, a connection determination is performed (S606). For example, as shown in FIG. 5, information is exchanged for determining suitability for a connection with MTC provider portion 504. Any known method for determining whether a connection is established may be used. If a connection is not made, the attempt continues (return to S604). Further, during this act, MTC should not be present in MTC loading portion 506. If testing portion 104 detects MTC within loading portion 506 there has been a problem with the production of manufactured device 502. In particular, had manufactured device 502 not been selected for testing, wherein testing portion 104 would not have detected the MTC within MTC loading portion, manufactured device 502 would have been shipped to a customer with the MTC loaded therein. This is unacceptable. As such, the MTC currently within MTC loading portion 506 should be removed and/or manufactured device 502 should be sent back to the manufacturing line.

The MTC provider is then authenticated (S608). For example, as shown in FIG. 5, verifying portion 508 authenticates, via communication channel 512, MTC provider portion 504. Any known method of authentication may be used, a non-limiting example of which includes those using digital certificates, public key exchanges and private key exchanges. In short, an unauthorized provider should not be granted access to load MTC onto a device. To ensure that an unauthorized provider does not gain access, any MTC provider that is attempting to load MTC must be authenticated. If MTC provider portion 504 is not authentic, verifying portion 508 will not pass any MTC provided by MTC provider portion 504 onto executing portion 114. Once MTC provider portion 504 is authenticated, any MTC provided must then additionally be authenticated. Verifying portion 508 then generates an MTC provider verification and provides the MTC provider verification to executing portion 114 via communication channel 514.

Returning to FIG. 6, then the MTC is downloaded from the MTC provider (S610). For example, as shown in FIG. 5, MTC providing portion 504 provides MTC information, via communication channel 510, to MTC loading portion 506. MTC information received by MTC loading portion 506 from MTC provider portion 504 includes the MTC. In this manner, the received MTC has been securely transferred and remains secure.

Returning to FIG. 6, the MTC is then authenticated (S210). An example of this operation is described above with reference to FIG. 2. Again, if the MTC is not authentic, verifying portion 508 does not pass the MTC onto executing portion 114. Once it is authenticated, it is able to be loaded. Verifying portion 508 then generates an MTC verification and provides the MTC verification to executing portion 114 via communication channel 514. In some embodiments, the MTC verification and the MTC provider verification may be a single verification provided to executing portion 114. In some embodiments the MTC verification and the MTC provider verification are provided separately to executing portion 114.

Returning to FIG. 6, the MTC is then executed (S612). For example, as shown in FIG. 5, testing portion 104 instructs MTC loading portion 506, via communication channel 120, to load the MTC into executing portion 114. MTC loading portion 506 then loads the MTC into executing portion 114 via communication channel 126. Testing portion 104 additionally instructs executing portion 114, via communication channel 122, to execute the MTC as provided by MTC loading portion 506. After receiving the MTC from MTC loading portion 506, receiving an instruction from testing portion 104, receiving the MTC verification from verifying portion 508 and receiving the MTC provider verification, executing portion 114 executes the MTC. Testing portion 104 then monitors the results of executed MTC. If there are any errors, the test may be repeated, the manufactured device may be returned to the beginning of the manufacturing line or the manufactured device may be discarded.

Returning to FIG. 6, the MTC is then deleted (S614). For purposes of discussion, in this example testing portion 104 has determined that manufactured device 502 has executed the MTC without any errors. In such a case, for example, testing portion 104 then removes the MTC from MTC loading portion 506 to prevent further execution and to prevent third parties from accessing the MTC. In this manner, the received MTC has been securely transferred, has been used and has then been removed from manufactured device 502. As a result the MTC remains secure.

Returning to FIG. 6, power is removed (S616). For example, manufactured device 502 is disconnected from power, from testing portion 104 and from MTC providing portion 504. At this point, method 600 is complete (S618).

In example method 600, manufactured device 502 verifies the authenticity of the MTC and the authenticity of MTC provider portion 504. More particularly, in example method 600, manufactured device 502 verifies the authenticity of MTC provider portion 504 prior to verifying the authenticity of the MTC. In some embodiments, manufactured device 502 may verify the authenticity of the MTC concurrently with the MTC. In still other embodiments, manufactured device 502 may verify the authenticity of the MTC provider after verifying the authenticity of the MTC.

Method 600 provides for selecting a sample of devices for re-testing such that the sampled devices may be configured for testing, testing may be performed and device may be returned to the condition prior to sampling/testing without being returned to the manufacturing line. The device is returned to the pre-tested state in order to be delivered to customers. In contrast, for some devices/systems, the device is returned to the manufacturing line in order to be reconfigured.

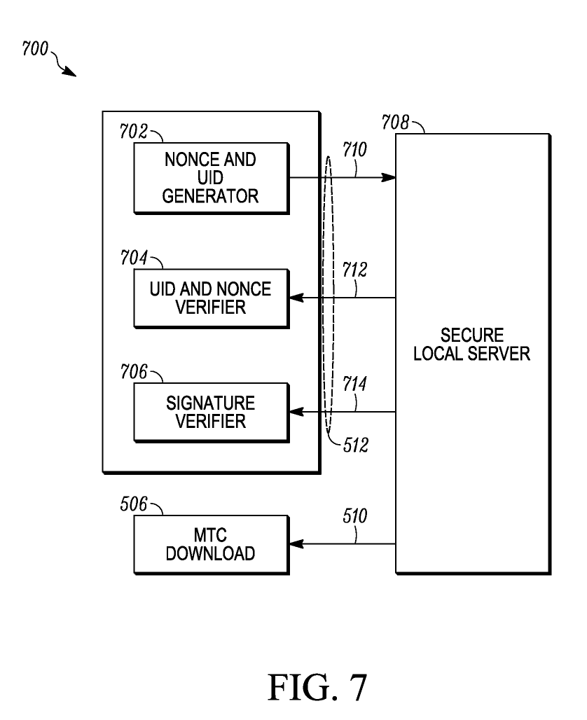

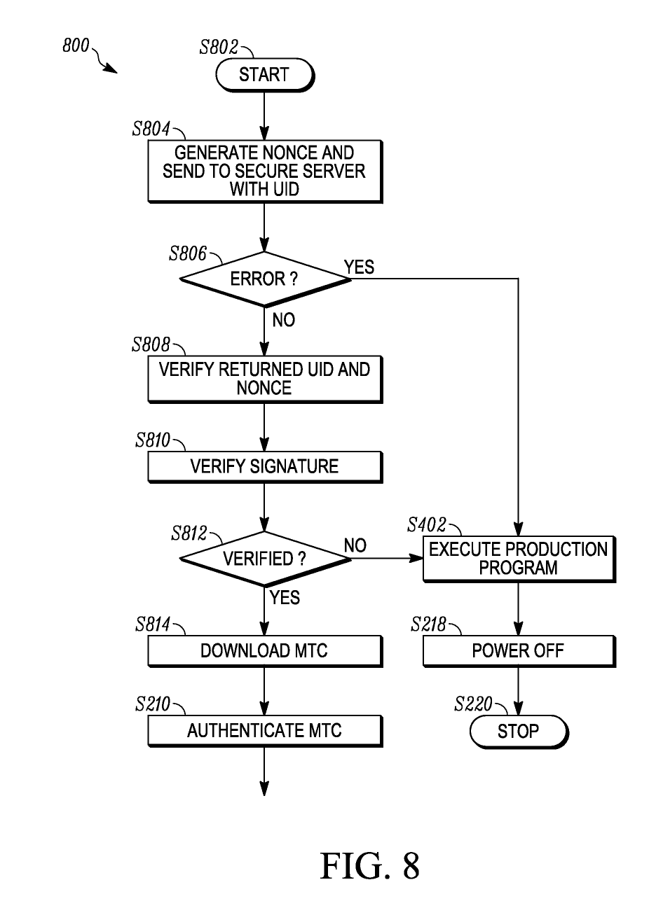

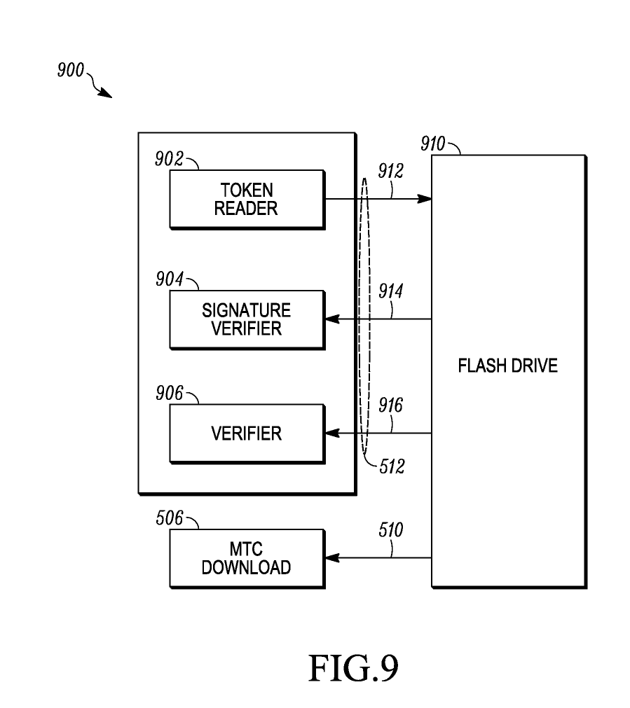

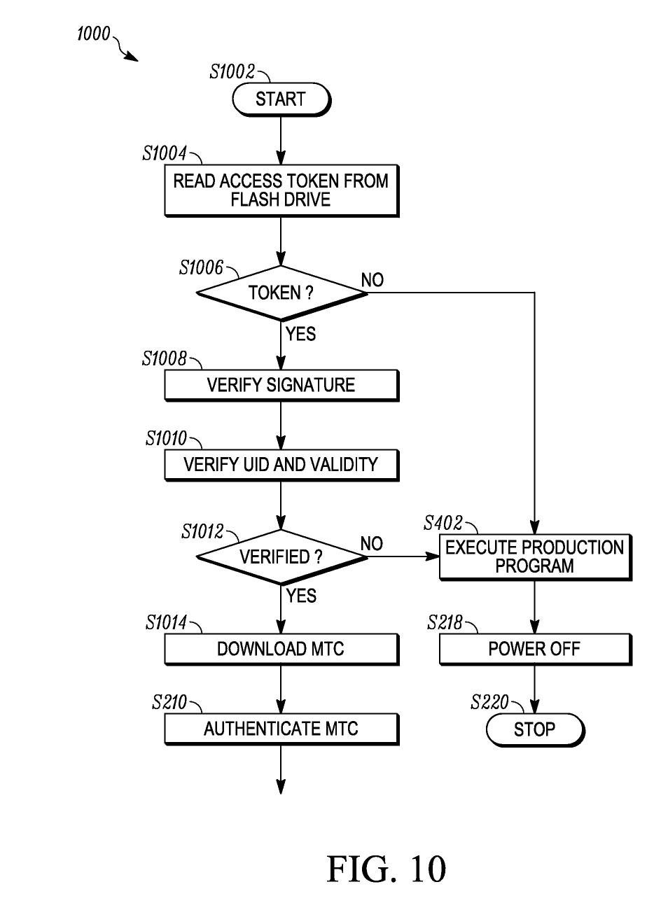

Two non-limiting example embodiments for securely providing MTC will be described with reference to FIGS. 7-10. A secure local server example embodiment will be described with reference to FIGS. 7-8, where MTC is provided by a secure local server, and a flash drive example embodiment will be described with reference to FIGS. 9-10, where MTC is provided by a flash drive.

The first situation where MTC is provided by a secure local server will now be described with reference to FIGS. 7-8.

FIG. 7 illustrates an example where an MTC providing portion 708 is a local server and corresponds to MTC provider 504 of FIG. 5, and where a verifying portion 700 corresponds to verifying portion 508 of FIG. 5. In this example, a nonce is created and communicated with unit identification information to a secure local server, unit identification information and nonce are returned and verified and the MTC is downloaded and executed.

Verifying portion 700 includes a nonce/UID generator portion 702, a UID/nonce verifier portion 704 and a signature verifier portion 706.

In this example, each of nonce/UID generator portion 702, UID/nonce verifier portion 704 and signature verifier portion 706 are distinct devices. However, in other embodiments, at least two of nonce/UID generator portion 702, UID/nonce verifier portion 704 and signature verifier portion 706 may be combined as a unitary device. Further, in some embodiments, at least one of nonce/UID generator portion 702, UID/nonce verifier portion 704 and signature verifier portion 706 may be implemented using non-transient, tangible computer-readable media for carrying or having computer-executable instructions or data structures stored thereon.

MTC providing portion 708 receives information 710 from nonce/UID generator portion 702 via communication channel 512. UID/nonce verifier portion 704 receives information 712 from MTC providing portion 708 via communication channel 512. Signature verifier portion 706 receives information 714 from MTC providing portion 708 via communication channel 512. MTC loading portion 506 receives information from MTC providing portion 708 via communication channel 510.

Nonce/UID generator generates information associated with a Nonce and unit identification information. A nonce is a randomly generated or pseudo-randomly generated number or string of information which is used one time for facilitating secure communication. UID/nonce verifier receives and verifies information associated with unit identification and a nonce. Signature verifier portion 706 verifies information receives associated with a signature. MTC loading portion 506 downloads information associated with the MTC.

System 700 provides for secure communication and download of MTC from a local server. For purposes of discussion, if an invalid device attempts to communicate with the server, the device is not allowed to download MTC. Furthermore, if an invalid server attempts to communicate with a secure device, then secure device does not download MTC. This prevents unauthorized access to secure devices by unauthorized servers and prevents unauthorized access to servers by unauthorized devices.

Operation of this system will be described with additional reference to FIG. 8.

FIG. 8 illustrates a method 800 for system 700 as described with reference to FIG. 7.

The method as described by FIG. 8 provides nonce generation, communication and verification, in addition to signature verification, MTC download and production program execution.

As shown in FIG. 8, method 800 starts (S802) by generating a nonce and communicating generated nonce with unit identification information to secure local server (S804). For example, as shown in FIG. 7, nonce/UID generator portion 702 creates a nonce and communicates generated nonce and unit identification information as information 710 to MTC providing portion 708 via communication channel 512. As a non-limiting example, a nonce of “1234abcd” may be created which is combined with unit identification information of “john doe” and communicated to the secure local server. MTC providing portion 708 receives nonce and unit identification information.

Returning to FIG. 8, a detection determination associated with an error is performed (S806). For example, an error may be detected for miscommunication of information.

Referring to FIG. 8, for not detecting an error, the unit identification information and nonce returned from the secure local server is verified (S808). For example, as shown in FIG. 7, MTC providing portion 708 returns nonce and identification as information 712 to UID/nonce verifier portion 704 via communication channel 512. As a non-limiting example, nonce “1234abcd” and unit identification of “john doe” is returned to UID/nonce verifier portion 704.

Returning to FIG. 8, the signature is then verified (S810). For example, as shown in FIG. 7, signature verifier portion 706 receives signature information as information 714 from MTC providing portion 708, via communication channel 512, and performs signature verification. Furthermore, signature may be encrypted as a way to perform verification.

Returning to FIG. 8, it is then determined whether the signature has been verified (S812).

If the signature is verified, the MTC is downloaded (S814). For example, as shown in FIG. 7, MTC loading portion 506 downloads the MTC from MTC providing portion 708 via communication channel 510. As a non-limiting example, the MTC may be downloaded for performing diagnostics associated with electronic semiconductor devices (e.g. memory test). At this point, the MTC is authenticated and the test continues as discussed above with reference to FIG. 6 (S612).

Returning to FIG. 8, if the MTC signature is not verified, then production program is executed (S402) as describe with reference to FIG. 4. The system powers off (S218) and method 800 stops (S220).

FIG. 8 illustrates a method for system 700, as described with reference to FIG. 7, where a nonce is created and communicated with unit identification information to a secure local server. The unit identification information and the nonce are returned and verified, wherein the MTC is downloaded.

The second situation where MTC is provided by a flash drive will now be described with reference to FIGS. 9-10.

FIG. 9 illustrates an example system 900, where an MTC providing portion 910 is a flash drive and corresponds to MTC provider 504 of FIG. 5, and where a verifying portion 900 corresponds to verifying portion 508 of FIG. 5. This example provides for secure communication and download of MTC from a flash drive. If a valid device attempts to communicate with an invalid flash drive, then the devices does not download MTC. This prevents unauthorized access to secure devices by unauthorized flash drives.

System 900 provides capability for a secure device receiving an access token from flash drive, the secure device verifying the signature, the secure device verifying the unit identifier and validity, the secure device downloading the MTC and the secure device executing the MTC associated with manufacture tests.

System 900 includes a token reader portion 902, a signature verifier portion 904, a verifier portion 906, a MTC loading portion 506 and a flash drive portion 910. Flash drive portion 910 includes flash memory, which is a non-volatile computer storage device with no moving parts that can be electrically erased and reprogrammed. A flash memory is used herein as a non-limiting example of a portable storage device.

Token reader portion 902 receives information 912 from flash drive portion 910 via communication channel 512. Signature verifier portion 904 receives information 914 from flash drive portion 910 via communication channel 512. Verifier portion 906 receives information 916 from flash drive portion 910 via communication channel 512. MTC loading portion 506 receives information from flash drive portion 910 via communication channel 510.

Token reader portion 902 performs operations associated with reading a token. Signature verifier portion 904 performs operations associated with verifying a signature. Verifier portion 906 performs operations associated with verifying unit identification and validity. MTC loading portion 506 performs operations associated with downloading the MTC.

Operation of this system will be described with additional reference to FIG. 10.

FIG. 10 illustrates a method 1000 for system 900 as described with reference to FIG. 9.

The method as described by FIG. 10 provides reading and verification of a token, verification of a signature, verification of unit identification and validity, downloading of the MTC and production program execution.

As shown in FIG. 10, method 1000 starts (S1002) by reading access token from flash drive (S1004). For example, as shown in FIG. 9, token reader portion 902 attempts to read access token from flash drive portion 910. Furthermore, token may include information associated with unit identification of unit and/or token expiration.

Returning to FIG. 10, a token presentation determination is performed (S1006). For example, token reader 902 may determine that a token is received as information 912 from flash drive portion 910 via communication channel 512. The token received may contain information, which when used in conjunction with later verification steps, allows the secure device to determine the token's validity and applicability.

Referring to FIG. 10, verification associated with a signature is then performed (S1008). For example, as shown in FIG. 9, signature verifier portion 904 receives signature, as information 914, from flash drive portion 910 via communication channel 512. Signature verifier portion 904 may then perform verification associated with the received signature. Any known verification method may be used, a non-limiting example of which includes a hard coded verification public key.

Returning to FIG. 10, verification of unit identification and validity is performed (S1010). For example, as shown in FIG. 9, verifier portion 906 performs verification associated with unit identification and validity. As a non-limiting example, the unit identification associated with the token may be compared for a match with the device unit identification. Furthermore, as a non-limiting example, the validity associated with the token may be performed.

Returning to FIG. 10, the verification result is tested (S1012).

Referring to FIG. 10, after verification of unit identity and validity, the MTC is downloaded (S1014). For example, as shown in FIG. 9, MTC loading portion 506 downloads the MTC from flash drive portion 910. As a non-limiting example, the MTC may perform diagnostics associated with an electronic memory device. At this point, the MTC is authenticated and the test continues as discussed above with reference to FIG. 6 (S210).

For not being presented with a token and not verifying unit identification and validity, then production program is executed as described with reference to FIG. 4 (S402), power off is performed as described with reference to FIG. 2 (S218) and method 1000 stops (S220).

FIG. 9 illustrates a method for the system as described with reference to FIG. 9 where token is read and verified for presentation, signature is verified, unit identification and validity is performed and the MTC is downloaded and executed.

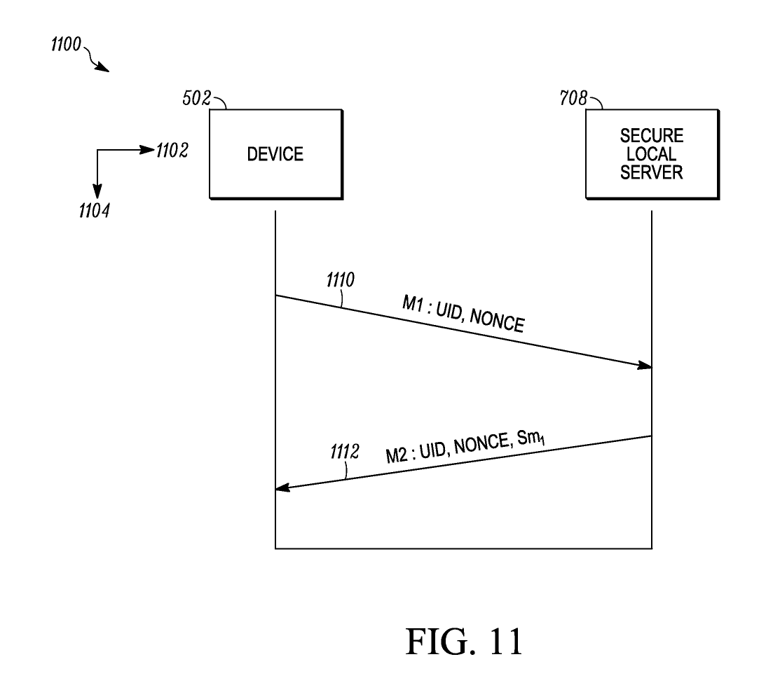

FIG. 11 illustrates an example communication exchange diagram for system as described with reference to FIGS. 6-7.

An x-axis 1102 represents exchanges of communication between a secure device and MTC providing portion 708 (as shown in FIG. 7) and a y-axis 1104 represents time with units of time.

Device may operate to communicate unit identification and nonce information to MTC providing portion 708 via a UID/nonce message 1110.

MTC providing portion 708 receives unit identification and nonce information and verifies if unit identification is in white list. If unit identification and nonce information are in the white list, then secure local server portion 708 may use its private key to sign the unit identification and nonce information.

MTC providing portion 708 communicates signed version of the unit identification and nonce version to device via a signed UID/nonce message 1112.

Device receives signed UID/nonce information and verifies unit identification and nonce match its own unit identification and nonce.

FIG. 11 illustrates an example communication exchange diagram for system as described with reference to FIGS. 7-8 where device communicates unit identification and nonce to secure local server, secure local server verifies unit identification is in white list, secure local server generates signed unit identification/nonce, secure local server communicates signed unit identification and nonce to device and device verifies received unit identification and nonce.

In the manufacture of some secure devices via systems, a random sample of devices is selected for re-testing. Following successful testing of the devices, the devices are not configured for delivery to customers, users, etc., as the devices have MTC information which is not to be delivered in devices to customers, users, etc. Therefore, in order to deliver some devices to customers and users, the devices are reconfigured via the original manufacturing line.

Devices may be configured to securely receive MTC information for performing sampled re-testing. In some example embodiments, devices securely receive information from secure local servers and in some example embodiments, devices securely receive information from flash drives. Following sampled re-testing, devices do not traverse some manufacturing lines, but rather are configured for delivery to customers and users as a part of the re-testing process or following the re-testing process. Following re-testing, the devices are delivered to customers and users in a similar manner as devices which are not sampled and re-tested.

Systems and methods have been described which provide capability for performing manufacture tests associated with the MTC in a secure manner. A local server embodiment and a flash drive embodiment have been described for implementing the systems and methods for secure manufacture test. The systems and methods prevent unauthorized entities from loading and executing unauthorized programming code.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to enable others skilled in the art to best utilize the invention in various embodiments and with various modifications as are suited to the particular use contemplated. It is intended that the scope of the invention be defined by the claims appended hereto.

What is claimed is:

1. A system comprising:
a device booting portion operable to boot a manufactured device;
an MTC loading portion operable to receive secure manufacturing test code from an MTC providing portion when the manufactured device does not have manufacturing test code stored therein; and
a verifying portion operable to verify authenticity of secure manufacturing test code and to generate a verification,
wherein said MTC loading portion is further operable to load the secure manufacturing test code into the booted manufactured device based on the verification.

2. The system of claim 1, further comprising an executing portion operable to execute one of the manufacturing test code and the secure manufacturing test code on the booted manufactured device.

3. The system of claim 2, wherein said MTC loading portion is operable to receive the secure manufacturing test code from a secure server as the MTC providing portion.

4. The system of claim 2, wherein said MTC loading portion is operable to receive the secure manufacturing test code from a non-transient, tangible, computer-readable media as the MTC providing portion.

5. The system of claim 1, wherein said MTC loading portion is operable to receive the secure manufacturing test code from a secure server as the MTC providing portion.

6. The system of claim 1, wherein said MTC loading portion is operable to receive the secure manufacturing test code from a non-transient, tangible, computer-readable media as the MTC providing portion.

7. A method comprising:
booting, via a device booting portion, a manufactured device;
determining, via a testing portion, whether the booted manufactured device has manufacturing test code stored therein;
providing, via an MTC providing portion, secure manufacturing test code when the testing portion determines that the booted manufactured device does not have manufacturing test code stored therein;
verifying, via a verifying portion, authenticity of the secure manufacturing test code;
generating, via the verifying portion, a verification; and
loading, via an MTC loading portion, the secure manufacturing test code into the booted manufactured device based on the verification.

8. The method of claim 7, further comprising executing, via an executing portion, one of the manufacturing test code and the secure manufacturing test code on the booted manufactured device.

9. The method of claim 8, further comprising:
verifying, via the verifying portion, authenticity of the MTC providing portion; and
generating, via the verifying portion, a second verification,
wherein said loading, via an MTC loading portion, the secure manufacturing test code into the booted manufactured device based on the verification comprises loading the secure manufacturing test code into the booted manufactured device additionally based on the second verification.

10. The method of claim 9, wherein said providing, via an MTC providing portion, secure manufacturing test code when the testing portion determines that the booted manufactured device does not have manufacturing test code stored therein comprises providing, via a secure server, secure manufacturing test code when the testing portion determines that the booted manufactured device does not have manufacturing test code stored therein.

11. The method of claim 9, wherein said providing, via an MTC providing portion, secure manufacturing test code when the testing portion determines that the booted manufactured device does not have manufacturing test code stored therein comprises providing, via a non-transient, tangible, computer-readable media, secure manufacturing test code when the testing portion determines that the booted manufactured device does not have manufacturing test code stored therein.

12. The method of claim 8, wherein said providing, via an MTC providing portion, secure manufacturing test code when the testing portion determines that the booted manufactured device does not have manufacturing test code stored therein comprises providing, via a secure server, secure manufacturing test code when the testing portion determines that the booted manufactured device does not have manufacturing test code stored therein.

13. The method of claim 8, wherein said providing, via an MTC providing portion, secure manufacturing test code when the testing portion determines that the booted manufactured device does not have manufacturing test code stored therein comprises providing, via a non-transient, tangible, computer-readable media, secure manufacturing test code when the testing portion determines that the booted manufactured device does not have manufacturing test code stored therein.

14. The method of claim 7, further comprising:
verifying, via the verifying portion, authenticity of the MTC providing portion; and
generating, via the verifying portion, a second verification,
wherein said loading, via an MTC loading portion, the secure manufacturing test code into the booted manufactured device based on the verification comprises loading the secure manufacturing test code into the booted manufactured device additionally based on the second verification.

15. The method of claim 14, wherein said providing, via an MTC providing portion, secure manufacturing test code when the testing portion determines that the booted manufactured device does not have manufacturing test code stored therein comprises providing, via a secure server, secure manufacturing test code when the testing portion determines that the booted manufactured device does not have manufacturing test code stored therein.

16. The method of claim 14, wherein said providing, via an MTC providing portion, secure manufacturing test code when the testing portion determines that the booted manufactured device does not have manufacturing test code stored therein comprises providing, via a non-transient, tangible, computer-readable media, secure manufacturing test code when the testing portion determines that the booted manufactured device does not have manufacturing test code stored therein.

17. The method of claim 7, wherein said providing, via an MTC providing portion, secure manufacturing test code when the testing portion determines that the booted manufactured device does not have manufacturing test code stored therein comprises providing, via a secure server, secure manufacturing test code when the testing portion determines that the booted manufactured device does not have manufacturing test code stored therein.

18. The method of claim 7, wherein said providing, via an MTC providing portion, secure manufacturing test code when the testing portion determines that the booted manufactured device does not have manufacturing test code stored therein comprises providing, via a non-transient, tangible, computer-readable media, secure manufacturing test code when the testing portion determines that the booted manufactured device does not have manufacturing test code stored therein.
